(19) United States
(12) Patent Application Publication
(10) Pub. No.: US 2024/0067224 A1
(43) Pub. Date: Feb. 29, 2024

(54) SMART PARKING SYSTEM AND METHOD

(71) Applicant: ELECTRONICS AND TELECOMMUNICATIONS RESEARCH INSTITUTE, Daejeon (KR)

(72) Inventors: Cheonin OH, Daejeon (KR); Daesub YOON, Daejeon (KR); Kyong Ho KIM, Daejeon (KR); Sung Woong SHIN, Daejeon (KR); Giyoung LEE, Daejeon (KR); Byung Bog LEE, Daejeon (KR); Ahyun LEE, Daejeon (KR)

(73) Assignee: ELECTRONICS AND TELECOMMUNICATIONS RESEARCH INSTITUTE, Daejeon (KR)

(21) Appl. No.: 18/454,923

(22) Filed: Aug. 24, 2023

(30) Foreign Application Priority Data
Aug. 25, 2022 (KR) 10-2022-0106711
Feb. 23, 2023 (KR) 10-2023-0024264

(51) Int. Cl. B60W 60/00; B60W 30/06

(52) U.S. Cl. CPC B60W 60/0025; B60W 30/06; B60W 2556/65; B60W 2756/10

(57) ABSTRACT

A vehicle parking method in a smart parking system is provided. The vehicle parking method includes measuring, by parked vehicles, inter-vehicle distance values by using sensors embedded therein, receiving, by a parking target vehicle, the inter-vehicle distance values from the parked vehicles by using vehicle-to-vehicle (V2V) communication, selecting one distance value from among the inter-vehicle distance values, and determining the selected distance value as a parking space, transmitting, by the parking target vehicle, a movement request message to two parked vehicles configuring the parking space by using the V2V communication, moving, by the two parked vehicles, based on the movement request message and extending the parking space to an available parking space, and performing, by the parking target vehicle, an automatic parking process for parking in the available parking space.

### CROSS-REFERENCE TO RELATED APPLICATIONS

This application claims the benefit of the Korean Patent Application Nos. 10-2022-0106711 filed on Aug. 25, 2022, and 10-2023-0024264 filed on Feb. 23, 2023, which are hereby incorporated by reference as if fully set forth herein.

### BACKGROUND

### Field of the Invention

The present invention relates to smart parking control technology.

### Discussion of the Related Art

An automatic parking function is equipped in self-driving vehicles which have been released recently. The automatic parking function is a very convenient function which autonomously searches for an available parking space between parked vehicles by using various sensors, and when the available parking space is found, automatically parks a self-driving vehicle in the found available parking space.

Moreover, there may be a situation where a parked vehicle simultaneously occupies two available parking spaces. In such a situation, although there is an available parking space, it is unable to search for available parking spaces. Therefore, a self-driving vehicle to park should move to another parking area and should again search for available parking spaces in the other parking area, and due to this, an undesired time may occur.

For example, when a self-driving vehicle to park or an external server may secure an available parking space by controlling the movement of a parked vehicle, an undesired time for which a new available parking space should be again searched for in another parking area may be reduced. However, research for developing a system for controlling the movement of a parked vehicle so as to enable a self-driving vehicle to park or an external server to secure an available parking space is still insufficient.

### SUMMARY

An aspect of the present invention is directed to providing a smart parking system and method in which a self-driving vehicle may control the movement of parked vehicles to secure an available parking space, based on vehicle-to-vehicle (V2V) communication or vehicle-to-infrastructure (V2I) communication.

To achieve these and other advantages and in accordance with the purpose of the invention, as embodied and broadly described herein, there is provided a vehicle parking method in a smart parking system, the vehicle parking method including: measuring, by parked vehicles, inter-vehicle distance values by using sensors embedded therein; receiving, by a parking target vehicle, the inter-vehicle distance values from the parked vehicles by using vehicle-to-vehicle (V2V) communication, selecting one distance value from among the inter-vehicle distance values, and determining the selected distance value as a parking space; transmitting, by the parking target vehicle, a movement request message to two parked vehicles configuring the parking space by using the V2V communication; moving, by the two parked vehicles, based on the movement request message and extending the parking space to an available parking space; and performing, by the parking target vehicle, an automatic parking process for parking in the available parking space.

In another aspect of the present invention, there is provided a vehicle parking method in a smart parking system, the vehicle parking method including: measuring, by parked vehicles, inter-vehicle distance values by using sensors embedded therein and transmitting the inter-vehicle distance values and vehicle information about the parked vehicles to a parking management server, based on vehicle-to-infrastructure (V2I) communication; generating, by the parking management server, parking space list information including the inter-vehicle distance values and the vehicle information and transmitting the parking space list information to a parking target vehicle, based on the V2I communication; determining, by the parking target vehicle, one parking space from among parking spaces between the parked vehicles, based on the parking space list information; moving, by the parking target vehicle, to the determined parking space and transmitting a movement request message to two parked vehicles configuring the determined parking space, based on vehicle-to-vehicle (V2V) communication; moving, by the two parked vehicles, based on the movement request message and extending the parking space to an available parking space; and performing, by the parking target vehicle, an automatic parking process for parking in the available parking space.

In another aspect of the present invention, there is provided a self-driving vehicle including: a communication device configured to receive distance values between parked vehicles from the parked vehicles, based on vehicle-to-vehicle (V2V) communication; a processor configured to determine, as a parking space, one distance value selected from among the distance values received through the communication device, generate a movement request message requesting movement of two parked vehicles configuring the determined parking space for extending the parking space to an available parking space, and transmit the movement request message to two parked vehicles through the communication device; and a steering control device configured to, when the movement of the two parked vehicles based on the movement request message is completed, perform an automatic parking process for parking in the available parking space.

In another aspect of the present invention, there is provided a vehicle parking method in a smart parking system, the vehicle parking method including: measuring, by parked vehicles, inter-vehicle distance values by using sensors embedded therein and transmitting the inter-vehicle distance values and vehicle information about the parked vehicles to a parking management server, based on vehicle-to-infrastructure (V2I) communication; transmitting, by the parking management server, a movement request message to two parked vehicles configuring a parking space corresponding to one distance value determined from among the inter-vehicle distance values, based on the V2I communication; moving, by the two parked vehicles, based on the movement request message and extending the parking space to an available parking space; and receiving, by a parking target vehicle, position information about the two parked vehicles from the parking management server, based on the V2I communication, moving to the available parking space according to the position information, and performing an automatic parking process for parking in the available parking space.

It is to be understood that both the foregoing general description and the following detailed description of the present invention are exemplary and explanatory and are intended to provide further explanation of the invention as claimed.

### BRIEF DESCRIPTION OF THE DRAWINGS

FIG. 1 is a diagram for describing a parking area according to various embodiments of the present invention.

FIG. 2 is a total configuration diagram of a smart parking system for implementing a V2I communication-based parking process of a self-driving vehicle according to an embodiment of the present invention.

FIG. 3 is a flowchart illustrating a parking process illustrated in FIG. 2.

FIG. 4 is a total configuration diagram of a smart parking system for implementing a V2V communication-based parking process of a self-driving vehicle according to another embodiment of the present invention.

FIG. 5 is a diagram for describing a parking space control process according to an embodiment of the present invention.

FIG. 6 is a flowchart of messages exchanged between a self-driving vehicle to park, a parked self-driving vehicle, and a parking management server, for describing the parking process illustrated in FIG. 4.

FIG. 7 is a schematic internal configuration diagram of a self-driving vehicle for performing an automatic parking process according to various embodiments of the present invention.

FIG. 8 is a flowchart for describing an automatic parking process according to another embodiment of the present invention.

### DETAILED DESCRIPTION OF THE INVENTION

Hereinafter, example embodiments of the invention will be described in detail with reference to the accompanying drawings. In describing the invention, to facilitate the entire understanding of the invention, like numbers refer to like elements throughout the description of the figures, and a repetitive description on the same element is not provided.

In the following description, the technical terms are used only for explain a specific exemplary embodiment while not limiting the present invention. The terms of a singular form may include plural forms unless referred to the contrary. The meaning of ‘comprise’, ‘include’, or ‘have’ specifies a property, a region, a fixed number, a step, a process, an element and/or a component but does not exclude other properties, regions, fixed numbers, steps, processes, elements and/or components.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

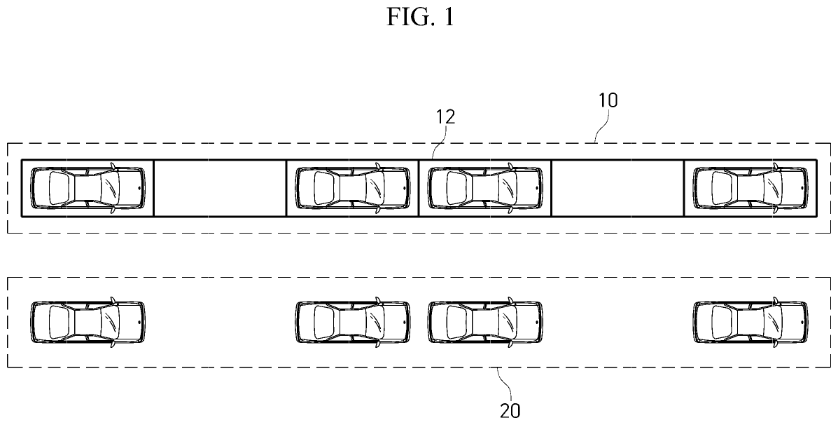

FIG. 1 is a diagram for describing a parking area according to various embodiments of the present invention.

Referring to FIG. 1, a parking area may include a parking area 10 where there is a parking line 12 and a parking area 20 where there is no parking line 12. Herein, it may be assumed that a self-driving vehicle performs an automatic parking process for parking in the parking area 20 where there is no parking line 12. However, it is obvious from the following description that the present invention may be applied to the automatic parking process for parking in the parking area 20 where there is no parking line 12.

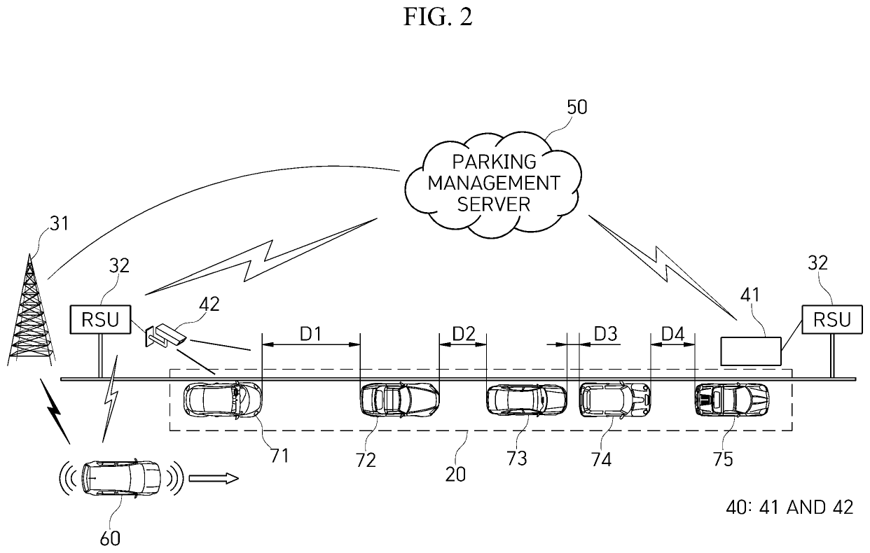

FIG. 2 is a total configuration diagram of a smart parking system for implementing a V2I communication-based parking process (or a parking scenario) of a self-driving vehicle according to an embodiment of the present invention.

Referring to FIG. 2, the smart parking system (or a parking management platform) according to an embodiment of the present invention may perform a parking process where a self-driving vehicle 60 parks in a parking space between general vehicles 71 to 75. Here, the general vehicles 71 to 75 may be defined as vehicles which have a V2I communication function and have no automatic parking function.

The smart parking system according to an embodiment of the present invention may include a base station 31, a road side unit (RSU) 32, an infrastructure sensor device 40 (41 and 42) equipped in the RSU 32, a parking management server 50, a self-driving vehicle 60, and general vehicles 71 to 75.

The infrastructure sensor device 40 may measure distance values D1 to D4 between parked vehicles 71 to 75. Also, the infrastructure sensor device 40 may transmit the measured distance values D1 to D4 to the parking management server 50 through the RSU 32.

To measure inter-vehicle distance values D1 to D4, the infrastructure sensor device 40 may include a distance measurement sensor 41 and an image sensor 42. The distance measurement sensor 41 may include, for example, an ultrasonic sensor, a radar sensor, or a LIDAR sensor. The image sensor 42 may include, for example, a camera or a closed circuit television (CCTV).

Moreover, the infrastructure sensor device 40 may further include a processor which controls operations of the distance measurement sensor 40 and the camera 41 and performs calculation and processing on data, a value, and an image obtained therefrom to calculate the inter-vehicle distance values D1 to D4. Here, the processor may include, for example, at least one central processing unit (CPU), at least one graphics processing unit (GPU), at least one micro controller unit (MCU), or at least one system on chip (SoC).

In a case which generates the inter-vehicle distance value D1 by using the distance measurement sensor 41, the processor may calculate, for example, the distance value D1 between the vehicle 71 and the vehicle 72 by using a triangulation technique, based on a distance value up to the vehicle 71 from the distance measurement sensor 41 and a distance value up to the vehicle 72 from the distance measurement sensor 41. Based on a similar method, the processor may calculate the other inter-vehicle distance values D2 to D4.

In a case which generates the inter-vehicle distance value D1 by using the image sensor 42, the processor may process, for example, an image which includes the vehicle 71 and the vehicle 72 and is obtained by the image sensor 42, thereby calculating the distance value D1 between the vehicle 71 and the vehicle 72.

In an embodiment, the processor may detect an edge line of each of the vehicle 71 and the vehicle 72 from the image and may calculate a pixel-unit distance value between the edge line of the vehicle 71 and the edge line of the vehicle 72. Also, the processor may convert the pixel-unit distance value into a real distance value between the vehicle 71 and the vehicle 72. Based on such a method, the processor may calculate the other inter-vehicle distance values D2 to D4.

To decrease a calculation load of the infrastructure sensor device 40, the parking management server 50 may calculate the inter-vehicle distance values D1 to D4. In this case, the infrastructure sensor device 40 may transmit source data to the parking management server 50. Here, the source data may include an image obtained by photographing the parked vehicles 71 to 75 or a distance value between the distance measurement sensor 41 and a parked vehicle.

Moreover, the infrastructure sensor device 40 may extract vehicle information from an image of each of the general vehicles 71 to 75 obtained by using the image sensor 42 and may transmit the extracted vehicle information to the parking management server 50 through the RSU 32.

The vehicle information may include, for example, a vehicle registration number and position information. The vehicle registration number may be obtained from the image by recognizing a vehicle license plate, based on an image processing algorithm and an artificial intelligence algorithm. According to another embodiment, each of the parked general vehicles 71 to 75 may directly transmit a vehicle registration number thereof to the parking management server 50 through the RSU 32 by using V2I communication. Also, each of the parked general vehicles 71 to 75 may transmit, as the vehicle information, position information (global positioning system (GPS) position coordinates) to the parking management server 50.

The parking management server 50 may generate parking situation information, based on the vehicle information and the inter-vehicle distance values D1 to D4 received from the infrastructure sensor device 400 through the base station 31 or the RSU 32. Also, the parking management server 50 may transmit the parking situation information to the self-driving vehicle 60 through the base station 31 and/or the RSU 32.

In an embodiment, the parking situation information may include vehicle information (for example, vehicle registration numbers) about the vehicles 71 to 75, parking congestion information, and parking space list information, and moreover, may further include parking fee information. The parking congestion information and the parking fee information may be used as information for enabling a driver to select a parking area from among a plurality of parking areas for example.

The parking congestion information may be information representing the number of many vehicles 71 to 75 parked in the parking area 20. The parking congestion information may be a ratio of a sum “D1+D2+D3+D4” of the inter-vehicle distance values D1 to D4 to a total length value L of the parking area 20.

The parking space list information may include vehicle information for identifying the inter-vehicle distance values D1 to D4 and each distance value. Here, the vehicle information may include position information or vehicle registration number information about two adjacent vehicles configuring each distance value. The following Table 1 may be an example of the parking space list information capable of being generated in a parking environment illustrated in FIG. 2.

TABLE 1

| | | Inter- |
|---|---|---|
| | | vehicle |
| | | distance |
| | Vehicle information | values |
| Parking | Position information about vehicle 71 and position | D1 |
| space 1 | information about vehicle 72 | |
| | Vehicle registration number of vehicle 71 and vehicle | |
| | registration number of vehicle 72 | |
| Parking | Position information about vehicle 72 and position | D2 |
| space 2 | information about vehicle 73 | |
| | Vehicle registration number of vehicle 72 and vehicle | |
| | registration number of vehicle 73 | |
| Parking | Position information about vehicle 73 and position | D3 |
| space 3 | information about vehicle 74 | |
| | Vehicle registration number of vehicle 73 and vehicle | |
| | registration number of vehicle 74 | |
| Parking | Position information about vehicle 74 and position | D4 |
| space 4 | information about vehicle 75 | |
| | Vehicle registration number of vehicle 74 and vehicle | |
| | registration number of vehicle 75 | |

The self-driving vehicle 60 may determine a parking area and a parking space in the parking area, based on the vehicle situation information received from the parking management server 50 through the base station 31 and/or the RSU 32, and may move to the determined parking area to perform an automatic parking process.

In an embodiment, the self-driving vehicle 60 may determine an appropriate parking area from among a plurality of parking areas by using the parking congestion information and/or the parking fee information included in the vehicle situation information. For example, the self-driving vehicle 60 may select a parking area, where a parking congestion rate is lowest or parking fee is lowest, from among the plurality of parking areas.

In an embodiment, a parking area may be passively selected through a graphical user interface (GUI) displayed by a display device equipped in the self-driving vehicle 60 or a GUI displayed by a driver terminal (for example, a smartphone) capable of performing wireless communication with a communication device equipped in the self-driving vehicle 60. Here, the wireless communication may include mobile communication such as 3G, 4G, or 5G and short-range wireless communication such as WiFi or Bluetooth.

In an embodiment, in a case where a parking area is automatically or passively selected, the self-driving vehicle 60 may analyze the parking space list information to select a parking space from among a plurality of parking spaces of the selected parking area. The parking space may be automatically or passively selected also.

The self-driving vehicle 60 may compare a target distance value with each of the inter-vehicle distance values D1 to D4 included in the parking space list information to determine a distance value, which is greater than or equal to the target distance value, as a parking space. For example, when there are a plurality of distance values which are greater than or equal to the target distance value, the self-driving vehicle 60 may determine a largest distance value as a parking space. Here, the target distance value may be a sum value of a length value of the self-driving vehicle 60 and a minimum distance value, needed for enabling the self-driving vehicle 60 to escape from the parking space without colliding with a parked vehicle, between the self-driving vehicle 60 and the parked vehicle.

When an available parking space is determined, the self-driving vehicle 60 may perform a series of parking process for moving to the available parking space and parking in the available parking space through an automatic parking function. To move to the available parking space, the self-driving vehicle 60 may use position information about two parked general vehicles configuring the available parking space.

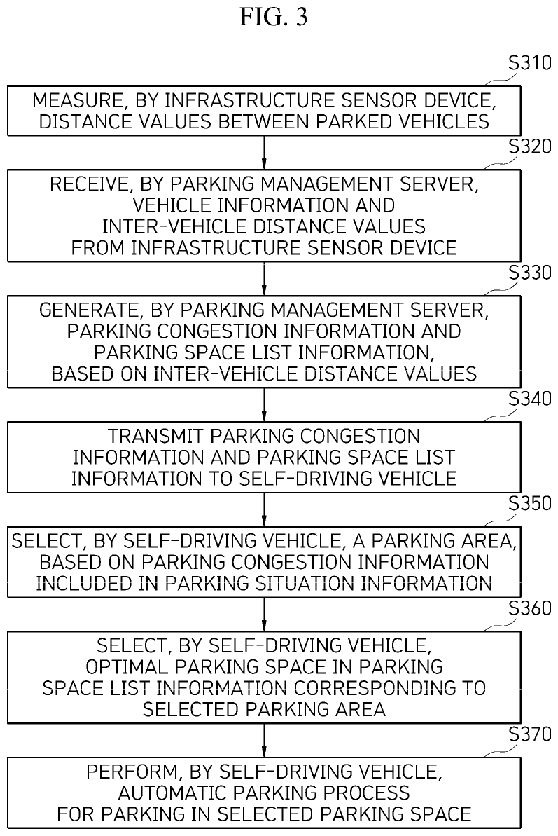

FIG. 3 is a flowchart illustrating the parking process illustrated in FIG. 2.

Referring to FIG. 3, first, in step S310, the infrastructure sensor device 40 may measure the distance values D1 to D4 between the parked vehicles 71 to 75.

Subsequently, in step S320, the parking management server 50 may receive vehicle information and the inter-vehicle distance values D1 to D5, measured by the infrastructure sensor device 40, through the base station 31 and/or the RSU 32.

Subsequently, in step S330, the parking management server 50 may generate parking congestion information and parking space list information, based on the vehicle information and the inter-vehicle distance values D1 to D5 received from the infrastructure sensor device 40.

Subsequently, in step S340, the parking management server 50 may generate parking situation information including the parking congestion information and the parking space list information and may transmit the parking situation information to the self-driving vehicle 60 through the base station 31 and/or the RSU 32. In this case, the parking situation information may be configured to further include parking fee information about a parking area.

Subsequently, in step S350, the self-driving vehicle 60 may select a parking area, based on the parking congestion information and/or the parking fee information included in the parking situation information. The selection of the parking area may be passively or automatically performed.

In a case where a parking area is passively selected, an internal GUI of the self-driving vehicle 60 may display a plurality of parking areas mapped to the parking congestion information and/or the parking fee information, and a driver of the self-driving vehicle 60 may select an appropriate parking area from among the displayed plurality of parking areas, based on a parking congestion rate and parking fee.

In a case where a parking area is automatically selected, the self-driving vehicle 60 may automatically select an optimal parking area which is located at a distance closest to a destination input to a navigation device by a driver and where a parking congestion rate or parking fee is lowest.

Subsequently, in step S360, when the selection of the parking area is completed, the self-driving vehicle 60 may analyze the inter-vehicle distance values D1 to D4 included in the parking space list information corresponding to the selected parking area to select an available parking space.

In an embodiment, the self-driving vehicle 60 may determine an inter-vehicle distance value, which is greater than or equal to a sum value of a vehicle length value of the self-driving vehicle 60 and a minimum distance value, needed for enabling the self-driving vehicle 60 to escape from the parking space, between the self-driving vehicle 60 and the parked vehicle, as a parking space from among the inter-vehicle distance values D1 to D4 included in the parking space list information.

Subsequently, in step S370, the self-driving vehicle 60 may move to the selected parking space and may perform an automatic parking process for parking in the selected parking space by using various sensors and a steering control device embedded therein.

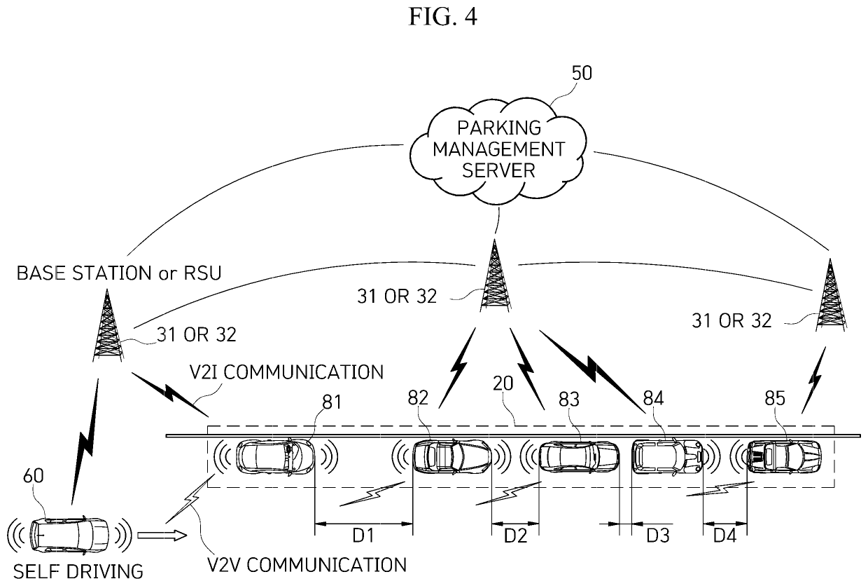

FIG. 4 is a total configuration diagram of a smart parking system for implementing a V2V communication-based parking process of a self-driving vehicle according to another embodiment of the present invention.

Referring to FIG. 4, the smart parking system according to another embodiment of the present invention may have a difference with the smart parking system illustrated in FIG. 2 in that parked vehicles are self-driving vehicles 81 to 85 instead of general vehicles (71 to 75 of FIG. 2) and an infrastructure sensor device (40 (41 and 42) of FIG. 2), and the other elements and an automatic parking process based thereon may be the same.

Moreover, the smart parking system according to another embodiment of the present invention may perform the automatic parking process by using all of V2I communication and V2V communication.

Moreover, in the smart parking system according to another embodiment of the present invention, because the parked self-driving vehicles 81 to 85 autonomously measure inter-vehicle distance values, it may not be needed that an RSU 23, on which the infrastructure sensor device 40 illustrated in FIG. 2 is attached, is disposed in a parking area 20.

Moreover, a smart parking system environment according to another embodiment of the present invention may be an environment where there is no infrastructure sensor device 40, inter-vehicle distance values d1 to d4 may be measured by a sensor (a camera, a radar, or LIDAR) equipped in each of the parked self-driving vehicles 81 to 85. For example, each of the parked self-driving vehicles 81 to 85 may measure a distance value up to another self-driving vehicle parked in a forward region or a rearward region with respect thereto by using a distance measurement sensor (for example, a radar sensor, a LIDAR sensor, or an ultrasonic sensor) embedded therein.

The parked self-driving vehicles 81 to 85 may transmit vehicle information, such as position information and vehicle registration numbers thereof in addition to the inter-vehicle distance values d1 to d4, to a parking management server 50 through a base station 31 and/or the RSU 32.

In an embodiment, the parking management server 50 may generate parking situation information, based on the inter-vehicle distance values d1 to d4 received from the parked self-driving vehicles 81 to 85, and may transmit the parking situation information to the self-driving vehicle 60, searching for parking spaces, through the base station 31 and/or the RSU 32. A process of generating the parking situation information may be the same as a process described above with reference to FIGS. 2 and 3.

In an embodiment, the parked self-driving vehicles 81 to 85 may directly transmit the vehicle information and the distance values d1 to d4 between self-driving vehicles to a self-driving vehicle 60 to park (a parking target vehicle) by using V2V communication without undergoing the parking management server 50. In this case, parking congestion information included in the parking situation information may be generated directly by the self-driving vehicle 60 searching for available parking spaces, based on the distance values d1 to d4 between self-driving vehicles.

In an embodiment, the self-driving vehicle 60 to park may perform an automatic parking process which selects a parking area and an available parking space in the parking area by using the parking situation information received from the parking management server 50 like a process described above with reference to FIGS. 2 and 3 and parks in the selected available parking space.

In an embodiment, the self-driving vehicle 60 to park may perform an automatic parking process which calculates a parking congestion rate by using the distance values d1 to d4 received from the parked self-driving vehicles 81 to 85, automatically or passively selects a parking area on the basis of the calculated parking congestion rate like a process described above with reference to FIGS. 2 and 3, selects an available parking space in the selected parking area, and parks in the selected available parking space.

Furthermore, there may be a case where there is no available parking space in a parking area. Such a case may be, for example, a case where the distance values d1 to d4 between self-driving vehicles parked in a current parking area are less than a target distance value corresponding to an available parking space.

In this case, the self-driving vehicle 60 may perform a parking space control process which determines one distance value from among the distance values d1 to d4 and extends a parking space, corresponding to the determined distance value, to an available parking space.

Based on the parking space control process, when the self-driving vehicle 60 does not detect an available parking space in a current parking area, an undesired time for which the self-driving vehicle 60 moves to another parking area and again searches for available parking spaces in the other parking area may be reduced.

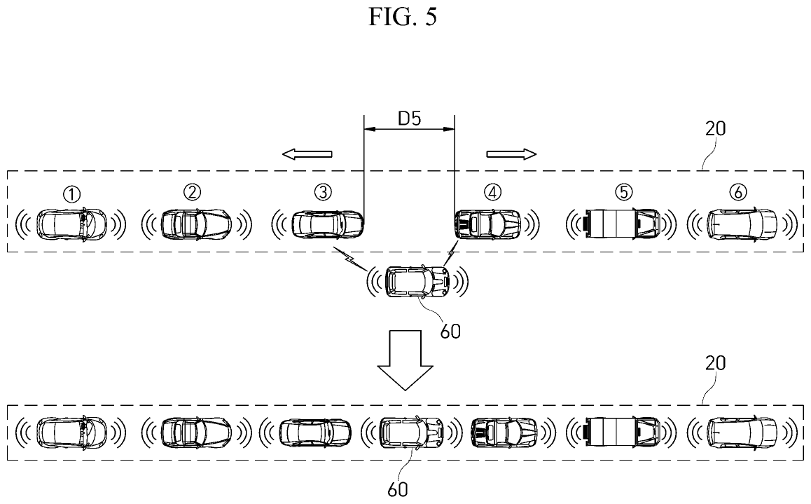

FIG. 5 is a diagram for describing a parking space control process according to an embodiment of the present invention.

Referring to FIG. 5, as described above, each of parked self-driving vehicles may measure a distance value up to another self-driving vehicle parked in a forward region or a rearward region with respect thereto by using a sensor (for example, a radar sensor, a LIDAR sensor, or an ultrasonic sensor) embedded therein and may transmit the measured distance values or parking situation information including the measured distance values to a self-driving vehicle 60 to park, based on V2I communication or/and V2V communication.

The self-driving vehicle 60 to park may move to an available parking space configuring a largest inter-vehicle distance value d5 of inter-vehicle distance values received from the parking management server 50 or the parked self-driving vehicles 81 to 85. In this case, the largest inter-vehicle distance value may be less than or equal to a length value of the self-driving vehicle 60. Accordingly, a current situation may be a situation where there is no available parking space in a current parking area 20.

Subsequently, the seld-driving vehicle 60 may transmit a message, requesting movement, to two parked self-driving vehicles \textcircled{3} and \textcircled{4} configuring the largest inter-vehicle distance value d5, based on V2V communication. For example, the self-driving vehicle 60 may request left movement from a left self-driving vehicle \textcircled{3} configuring the inter-vehicle distance value d5 on the basis of a movement request message and may request right movement from a right self-driving vehicle \textcircled{4} configuring the inter-vehicle distance value d5.

A movement distance value of each of the parked self-driving vehicles \textcircled{3} and \textcircled{4} may be determined based on a sum value of a length value of the self-driving vehicle 60 and a minimum distance value, needed for enabling the self-driving vehicle 60 to escape from a parking space, between the self-driving vehicle 60 and each of the parked self-driving vehicles \textcircled{3} and \textcircled{4}. For example, the movement distance value of each of the parked self-driving vehicles \textcircled{3} and \textcircled{4} may be a difference value between the sum value and the inter-vehicle distance value d5. The self-driving vehicle 60 may add the movement distance value to the movement request message and may transmit the movement request message including the movement distance value to the parked self-driving vehicles \textcircled{3} and \textcircled{4}.

Subsequently, when a previous inter-vehicle distance value is adjusted to a parking-enabled inter-vehicle distance value on the basis of the parked self-driving vehicles \textcircled{3} and \textcircled{4}, the self-driving vehicle 60 may perform an automatic parking process for parking in an available parking space corresponding to the adjusted inter-vehicle distance value.

Moreover, despite the movement of the parked self-driving vehicles \textcircled{3} and \textcircled{4}, there may be a case where a parking-enabled inter-vehicle distance value is secured. For example, in a process where the parked self-driving vehicle \textcircled{3} drives backward toward a self-driving vehicle \textcircled{2}, a collision-avoidance assist system with the parked self-driving vehicle \textcircled{3} embedded therein may recognize the self-driving vehicle \textcircled{2} as an obstacle, and thus, the parked self-driving vehicle \textcircled{3} may not move by the movement distance value requested by the self-driving vehicle 60 and may stop.

In this case, the parked self-driving vehicle \textcircled{3} may request movement from the self-driving vehicle \textcircled{2} hindering movement, based on V2V communication, and when the movement of the self-driving vehicle \textcircled{2} is completed, the parked self-driving vehicle \textcircled{3} may additionally move, thereby securing a parking-enabled inter-vehicle distance value.

Based on the same method, the parked self-driving vehicle \textcircled{4} may request movement from the self-driving vehicle \textcircled{5}, based on V2V communication, and when the movement of the self-driving vehicle \textcircled{5} is completed, the parked self-driving vehicle \textcircled{4} may additionally move, thereby securing a parking-enabled inter-vehicle distance value.

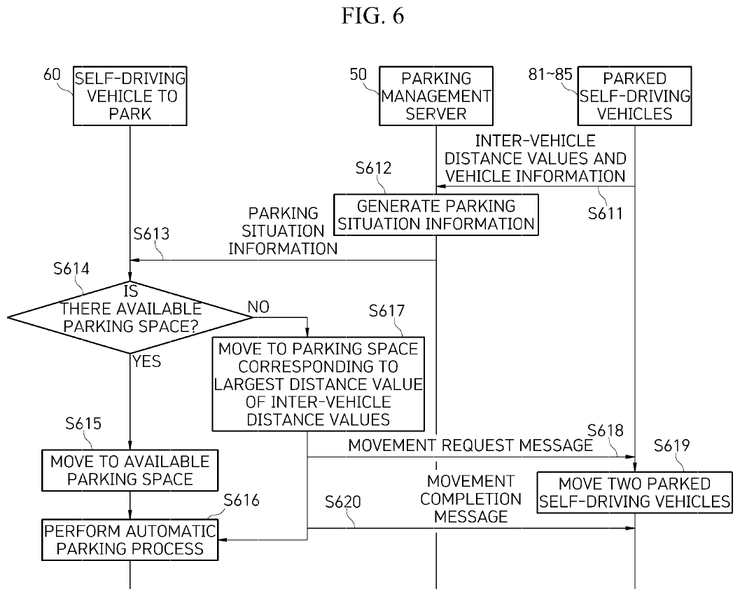

FIG. 6 is a flowchart of messages exchanged between a self-driving vehicle to park, a parked self-driving vehicle, and a parking management server, for describing the parking process illustrated in FIG. 4.

Referring to FIG. 6, first, in step S611, parked self-driving vehicles 81 to 85 may measure inter-vehicle distance values d1 to d4 by using sensors (for example, a radar sensor, a LIDAR sensor, or an ultrasonic sensor) embedded therein and may transmit the measured inter-vehicle distance values d1 to d4 to a parking management server 50 through the base station 31 and/or the RSU 32. In this case, each of the parked self-driving vehicles 81 to 85 may further transmit vehicle information (for example, a vehicle registration number and/or position information) thereof to the parking management server 50.

Subsequently, in step S612, the parking management server 50 may generate parking situation information, based on vehicle information and/or distance values d1 to d4 received from the parked self-driving vehicles 81 to 85. Here, the parking situation information may include a parking congestion rate generated based on the inter-vehicle distance values d1 to d4 and parking space list information (for example, Table 1) generated based on the inter-vehicle distance values d1 to d4 and the vehicle information.

Subsequently, in step S613, the parking management server 50 may transmit the generated parking situation information to the self-driving vehicle 60 to park through the base station 31 and/or the RSU 32. In this case, the parked self-driving vehicles 81 to 85 may directly transmit the inter-vehicle distance values and the vehicle information to the self-driving vehicle 60 to park, based on V2V communication, and in this case, steps S611 to S613 may be omitted.

Subsequently, in step S614, the self-driving vehicle 60 to park may select a parking area, based on the parking situation information, and may determine whether an available parking space is in the selected parking area or not. For example, the self-driving vehicle 60 may select a parking area, based on a parking congestion rate included in the parking situation information, and may determine whether an available parking space, corresponding to a distance value which is greater than or equal to a target distance value among distance values (for example, d1 to d4 of FIG. 4) included in the parking space list information, is in the selected parking area or not. Here, the target distance value may be a sum value of a length value of the self-driving vehicle 60 and a minimum distance value (a previously set value), needed for enabling the self-driving vehicle 60 to escape from the parking space without colliding with a parked vehicle, between the self-driving vehicle 60 and the parked vehicle.

Subsequently, in step S615, when there is an available parking space, the self-driving vehicle 60 may move to the available parking space, based on position information about a parked vehicle configuring the available parking space.

Subsequently, in step S616, the self-driving vehicle 60 may perform an automatic parking process to park in the available parking space.

On the other hand, when there is no available parking space in step S614, namely, when all of the distance values (for example, d1 to d4 of FIG. 4) included in the parking space list information are less than the target distance value, the self-driving vehicle 60 may select a largest distance value from among the distance values d1 to d4 and may move to a parking space corresponding to selected distance value in step S617. Here, the self-driving vehicle 60 may move to the parking space, based on position information about two parked self-driving vehicles (for example, \textcircled{3} and \textcircled{4} of FIG. 5) configuring the selected distance value.

Subsequently, in step S618, in a case where the self-driving vehicle 60 moves to a periphery of the parking space and is capable of performing V2V communication with the two parked self-driving vehicles (for example, \textcircled{3} and \textcircled{4} of FIG. 5), the self-driving vehicle 60 may transmit, to the two parked self-driving vehicles (for example, \textcircled{3} and \textcircled{4} of FIG. 5), a movement request message for extending the parking space to an available parking space on the basis of V2V communication. Here, the movement request message may include a movement distance value calculated by the self-driving vehicle 60, and the two parked self-driving vehicles (for example, \textcircled{3} and \textcircled{4} of FIG. 5) may move based on the movement distance value. In this case, the movement distance value may be determined based on a difference value between the target distance value and the selected distance value.

Subsequently, in step S619, the two parked self-driving vehicles may move based on the movement distance value and may extend the parking space to an available parking space. In this case, when the movement of the two parked self-driving vehicles (for example, \textcircled{3} and \textcircled{4} of FIG. 5) is limited by other parked self-driving vehicles (for example, \textcircled{2} and \textcircled{5} of FIG. 5), the two parked self-driving vehicles (for example, \textcircled{3} and \textcircled{4} of FIG. 5) may request left and right movement from the other parked self-driving vehicles (for example, \textcircled{2} and \textcircled{5} of FIG. 5), based on V2V communication, and when the other parked self-driving vehicles (for example, \textcircled{2} and \textcircled{5} of FIG. 5) move, the two parked self-driving vehicles (for example, \textcircled{3} and \textcircled{4} of FIG. 5) may continuously move.

Subsequently, in step S620, when the movement of the parked self-driving vehicles (for example, \textcircled{3} and \textcircled{4} of FIG. 5) is completed, the two parked self-driving vehicles (for example, \textcircled{3} and \textcircled{4} of FIG. 5) may transmit a movement completion message to the self-driving vehicle 60, based on V2V communication.

Subsequently, in step S616, the self-driving vehicle 60 may perform an automatic parking process for paring in the available parking space, based on receiving the movement completion message.

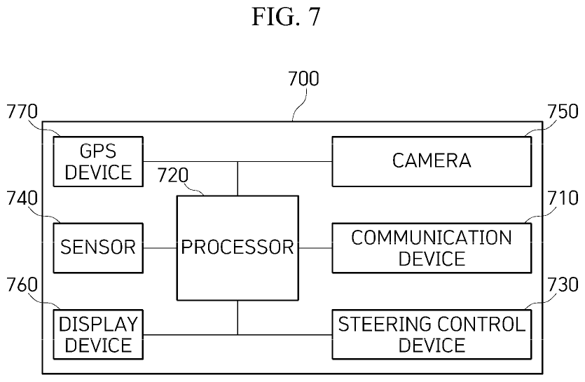

FIG. 7 is a schematic internal configuration diagram of a self-driving vehicle 700 for performing an automatic parking process according to various embodiments of the present invention.

Referring to FIG. 7, the self-driving vehicle 700 may be a vehicle to park or a parked vehicle. The self-driving vehicle 700 may include a communication device 710, a processor 720, a steering control device 730, a sensor 740, a camera 750, and a display device 760.

The communication device 710 may be a device which supports V2I communication and V2V communication. V2I communication and V2V communication have been described in detail in relevant standards such as ITU-R SG5 and ISO TC 204 (communication access for land mobiles (CALM)), in addition to IEEE 802.11.p (wireless access in vehicular environment (WAVE)) based on dedicated short-range communication (DSRC), and thus, detailed description thereof may be omitted. However, in the drawings, for conciseness of description, although one communication device 710 is illustrated, the communication device 710 may be divided into a communication device for V2I communication and a communication device for V2V communication.

In an embodiment, the communication device 710 may receive inter-vehicle distance values (D1 to D4 of FIG. 2 and/or d1 to d4 of FIG. 4) measured from the parked vehicles (71 to 75 of FIG. 2 or 81 to 85 of FIG. 4) and vehicle information (vehicle registration numbers and/or position information) measured from the parked vehicles (71 to 75 of FIG. 2 or 81 to 85 of FIG. 4), based on V2V communication.

In an embodiment, the communication device 710 may receive parking situation information from the parking management server 50, based on V2I communication. The parking situation information may include parking congestion information, parking space list information, and parking fee information about a parking area.

In an embodiment, the communication device 710 may support mobile communication (3G, 4G, 5G, 6G, etc.) and short-range wireless communication. Based on such mobile communication and short-range wireless communication, the communication device 70 may communicate with a driver terminal (for example, a smartphone).

The processor 720 may control and manage overall operations of the elements 710, 730, 740, 750, and 760. The processor 720 may include, for example, at least one CPU, at least one GPU, at least one MCU, or at least one SoC. Also, the processor 720 may be referred to as an electronic control unit (ECU) equipped in vehicles.

In an embodiment, the processor 720 may receive the inter-vehicle distance values (D1 to D4 of FIG. 2 and/or d1 to d4 of FIG. 4) from the parked vehicles (71 to 75 of FIG. 2 or 81 to 85 of FIG. 4) through the communication device 710 and may perform a processor which selects one distance value from among the inter-vehicle distance values (D1 to D4 of FIG. 2 and/or d1 to d4 of FIG. 4) and determines the selected distance value as a parking space.

In an embodiment, the processor 720 may perform a process which analyzes the distance values to determine whether there is an available parking space or not and a process which, when it is determined that there is no available parking space, determines a largest distance value of the inter-vehicle distance values (D1 to D4 of FIG. 2 and/or d1 to d4 of FIG. 4) as the parking space.

In an embodiment, the processor 720 may perform a process which compares the distance values with a target distance value corresponding to the available parking space and a process which, when all of the inter-vehicle distance values (D1 to D4 of FIG. 2 and/or d1 to d4 of FIG. 4) are less than the target distance value, determines a largest distance value of the distance values as the parking space. Here, the target distance value may be a sum value of a length value of the self-driving vehicle 700 (a parking target vehicle) and a minimum distance value, needed for enabling the parking target vehicle to escape from the parking space without colliding with a parked vehicle, between the parking target vehicle and the parked vehicle.

In an embodiment, the processor 720 may perform a process which generates a movement request message for requesting movement of two parked vehicles (for example, \textcircled{3} and \textcircled{4} of FIG. 5) configuring the parking space.

In an embodiment, the processor 720 may perform a process which controls the communication device 710 to transmit the movement request message to the two parked vehicles (for example, \textcircled{3} and \textcircled{4} of FIG. 5) configuring the parking space.

In an embodiment, the processor 720 may perform a process which calculates movement distance values of the two parked vehicles (for example, \textcircled{3} and \textcircled{4} of FIG. 5), and the movement distance value may be included in the movement request message.

In an embodiment, the movement distance value may be a difference value between the target distance value and a distance value selected from among the distance values.

In an embodiment, the two parked vehicles (for example, \textcircled{3} and \textcircled{4} of FIG. 5) may perform a process which moves based on the movement request message and extends the parking space to an available parking space.

The steering control device 730 and the sensor 740 may be devices for performing an automatic parking process of parking the self-driving vehicle 700 in an available parking space and may be one of devices configuring a smart parking assist system.

The sensor 740 may include a front sensor and a rear sensor installed in a front bumper and a rear bumper. Each of the front bumper and the rear bumper may be a distance measurement sensor. The distance measurement sensor may be, for example, a radar sensor, a LIDAR sensor, or an ultrasonic sensor. When the self-driving vehicle 700 is a parked vehicle, the sensors may measure distance values between parked vehicles.

The camera 750 may include a front camera and a rear camera installed in the front bumper and the rear bumper and may further include a camera installed in a side surface of the self-driving vehicle 700.

When the self-driving vehicle 700 is a parked vehicle, the camera 750 may obtain a license plate image of a vehicle which is parked in a forward region or a rearward region with respect to the self-driving vehicle 700. In this case, the processor 720 may obtain a vehicle registration number of the vehicle, parked in the forward region or the rearward region, from the license plate image on the basis of an image recognition algorithm.

The display device 760 may be an infortainment system installed in a self-driving vehicle. The display device 760 may display the parking space list information of Table 1 and the inter-vehicle distance values (D1 to D4 of FIG. 2 and/or d1 to d4 of FIG. 4) received from the parked vehicles (71 to 75 of FIG. 2 or 81 to 85 of FIG. 4) so that a driver passively selects a parking space.

A GPS device 770 may provide position information about the self-driving vehicle 700.

Furthermore, although elements associated with an automatic parking function are not illustrated, the self-driving vehicle 700 may be configured to further include various devices and systems known to those skilled in the art. For example, the self-driving vehicle 700 may be configured to further include a collision-avoidance assist system, an advanced driver assistance system (ADAS), a lane departure warning system, and a lane following assist system.

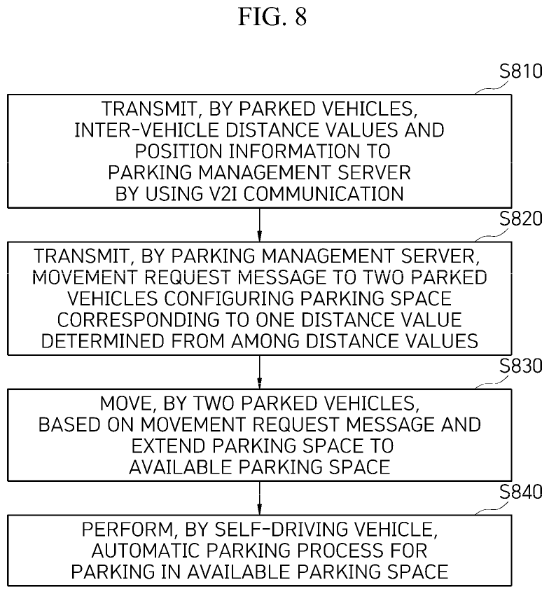

FIG. 8 is a flowchart for describing an automatic parking process according to another embodiment of the present invention.

Referring to FIG. 8, the automatic parking process according to another embodiment of the present invention may have a difference with the automatic parking process, where the self-driving vehicle 60 to park requests movement from the parked self-driving vehicles 81 to 85, of FIG. 4 in that the parking management server 50 requests movement from the parked self-driving vehicles 81 to 85 so as to secure an available parking space.

In detail, in step S810, the parked vehicles 81 to 85 may measure the inter-vehicle distance values d1 to d4 by using sensors embedded therein and may transmit the distance values and position information about the parked vehicles to the parking management server 50, based on V2I communication.

Subsequently, in step S820, the parking management server 50 may transmit a movement request message to two parked vehicles configuring a parking space corresponding to one distance value determined from among the distance values, based on V2I communication. In detail, the parking management server 50 may determine whether there is a distance value, which is greater than or equal to a target distance value corresponding to an available parking space, of distance values received from the parked vehicles 81 to 85, and when there is no distance value, the parking management server 50 may determine a parking space corresponding to a largest distance value of the distance values. Also, the parking management server 50 may transmit the movement request message to two parked vehicles configuring the determined parking space. Here, the target distance value may be a sum value of a length value of a self-driving vehicle and a minimum distance value, needed for enabling the self-driving vehicle to escape from the parking space without colliding with a parked vehicle, between the self-driving vehicle and the parked vehicle.

Subsequently, in step S830, the two parked vehicles (for example, \textcircled{3} and \textcircled{4} of FIG. 5) may move based on the movement request message and extend the parking space to an available parking space.

Subsequently, in step S840, the self-driving vehicle 60 may perform an automatic parking process which receives position information about the two parked vehicles from the parking management server on the basis of V2I communication, moves to the available parking space on the basis of the position information, and parks in the available parking space.

According to the embodiments of the present invention, in a situation where a self-driving vehicle to park may not park in a parking space because the parking space between parked vehicles is insufficient, the self-driving vehicle to park may control the movement of the parked vehicles on the basis of V2V communication without being supported by an infrastructure sensor, and thus, may extend the parking space to an available parking space.

Accordingly, an undesired time for which the self-driving vehicle to park in the situation moves to another parking area and again searches for available parking spaces in the other parking area may be reduced.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A vehicle parking method in a smart parking system, the vehicle parking method comprising:
measuring, by parked vehicles, inter-vehicle distance values by using sensors embedded therein;
receiving, by a parking target vehicle, the inter-vehicle distance values from the parked vehicles by using vehicle-to-vehicle (V2V) communication, selecting one distance value from among the inter-vehicle distance values, and determining the selected distance value as a parking space;
transmitting, by the parking target vehicle, a movement request message to two parked vehicles configuring the parking space by using the V2V communication;
moving, by the two parked vehicles, based on the movement request message and extending the parking space to an available parking space; and
performing, by the parking target vehicle, an automatic parking process for parking in the available parking space.

2. The vehicle parking method of claim 1, wherein the determining of the selected distance value as the parking space comprises:
analyzing the inter-vehicle distance values to determine whether there is an available parking space; and
when it is determined that there is no available parking space, determining a largest distance value of the inter-vehicle distance values as the parking space.

3. The vehicle parking method of claim 1, wherein the determining of the selected distance value as the parking space comprises:
comparing the inter-vehicle distance values with a target distance value corresponding to the available parking space; and
when the inter-vehicle distance values are less than the target distance value, determining a largest distance value of the inter-vehicle distance values as the parking space.

4. The vehicle parking method of claim 3, wherein the target distance value is a sum value of a length value of the parking target vehicle and a minimum distance value, needed for enabling the parking target vehicle to escape from the parking space without colliding with a parked vehicle, between the parking target vehicle and the parked vehicle.

5. The vehicle parking method of claim 1, wherein the transmitting of the movement request message to the two parked vehicles comprises:
generating the movement request message including a movement distance value calculated by the parking target vehicle; and
transmitting the movement request message to the two parked vehicles.

6. The vehicle parking method of claim 5, wherein the movement distance value is a difference value between a target distance value and a distance value selected from among the inter-vehicle distance values, and
the target distance value is a sum value of a length value of the parking target vehicle and a minimum distance value, needed for enabling the parking target vehicle to escape from the parking space without colliding with a parked vehicle, between the parking target vehicle and the parked vehicle.

7. The vehicle parking method of claim 1, wherein the extending of the parking space to the available parking space comprises:
when movement of the two parked self-driving vehicles is limited by other parked vehicles, transmitting, by the two parked vehicles, the movement request message to the other parked vehicles by using the V2V communication; and
completing movement of the other parked vehicles, movement and performing movement of the two parked vehicles.

8. A vehicle parking method in a smart parking system, the vehicle parking method comprising:
measuring, by parked vehicles, inter-vehicle distance values by using sensors embedded therein and transmitting the inter-vehicle distance values and vehicle information about the parked vehicles to a parking management server, based on vehicle-to-infrastructure (V2I) communication;
generating, by the parking management server, parking space list information including the inter-vehicle distance values and the vehicle information and transmitting the parking space list information to a parking target vehicle, based on the V2I communication;
determining, by the parking target vehicle, one parking space from among parking spaces between the parked vehicles, based on the parking space list information;
moving, by the parking target vehicle, to the determined parking space and transmitting a movement request message to two parked vehicles configuring the determined parking space, based on vehicle-to-vehicle (V2V) communication;
moving, by the two parked vehicles, based on the movement request message and extending the parking space to an available parking space; and
performing, by the parking target vehicle, an automatic parking process for parking in the available parking space.

9. The vehicle parking method of claim 8, wherein the determining of the parking space comprises:
comparing the inter-vehicle distance values included in the parking space list information with a target distance value set to an available parking space; and
when all of the inter-vehicle distance values are less than the target distance value, determining a largest distance value of the inter-vehicle distance values as the parking space.

10. The vehicle parking method of claim 9, wherein the target distance value is a sum value of a length value of the parking target vehicle and a minimum distance value, needed for enabling the parking target vehicle to escape from the parking space without colliding with a parked vehicle, between the parking target vehicle and the parked vehicle.

11. The vehicle parking method of claim 8, wherein the transmitting of the movement request message to the two parked vehicles comprises moving to the determined parking space, based on the vehicle information included in the parking space list information, and
the vehicle information comprises position information about the two parked vehicles configuring the determined parking space.

12. A self-driving vehicle comprising:
a communication device configured to receive distance values between parked vehicles from the parked vehicles, based on vehicle-to-vehicle (V2V) communication;
a processor configured to determine, as a parking space, one distance value selected from among the distance values received through the communication device, generate a movement request message requesting movement of two parked vehicles configuring the determined parking space for extending the parking space to an available parking space, and transmit the movement request message to two parked vehicles through the communication device; and
a steering control device configured to, when the movement of the two parked vehicles based on the movement request message is completed, perform an automatic parking process for parking in the available parking space.

13. The self-driving vehicle of claim 12, wherein the processor analyzes the distance values to determine whether there is an available parking space and when it is determined that there is no available parking space, determining a largest distance value of the distance values as the parking space.

14. The self-driving vehicle of claim 12, wherein the processor compares the distance values with a target distance value corresponding to the available parking space and when all of the distance values are less than the target distance value, determines a largest distance value of the distance values as the parking space.

15. The self-driving vehicle of claim 12, wherein the processor calculates a movement distance value needed for movement of the two parked vehicles and generates the movement request message including the movement distance value.

16. The self-driving vehicle of claim 15, wherein the movement distance value is a difference value between a target distance value and a distance value, corresponding to the parking space, of the distance values, and
the target distance value is a sum value of a length value of the self-driving vehicle and a minimum distance value, needed for enabling the self-driving vehicle to escape from the parking space without colliding with a parked vehicle, between the self-driving vehicle and the parked vehicle.

17. A vehicle parking method in a smart parking system, the vehicle parking method comprising:
measuring, by parked vehicles, inter-vehicle distance values by using sensors embedded therein and transmitting the inter-vehicle distance values and vehicle information about the parked vehicles to a parking management server, based on vehicle-to-infrastructure (V2I) communication;
transmitting, by the parking management server, a movement request message to two parked vehicles configuring a parking space corresponding to one distance value determined from among the inter-vehicle distance values, based on the V2I communication;
moving, by the two parked vehicles, based on the movement request message and extending the parking space to an available parking space; and
receiving, by a parking target vehicle, position information about the two parked vehicles from the parking management server, based on the V2I communication, moving to the available parking space according to the position information, and performing an automatic parking process for parking in the available parking space.
